(19) United States
(12) Patent Application Publication
(10) Pub. No.: US 2014/0095925 A1
(43) Pub. Date: Apr. 3, 2014

(54) CLIENT FOR CONTROLLING AUTOMATIC FAILOVER FROM A PRIMARY TO A STANDBY SERVER

(71) Applicants: JASON WILSON, Toronto (CA); Raul Sinimae, Toronto (CA)

(72) Inventors: JASON WILSON, Toronto (CA); Raul Sinimae, Toronto (CA)

(21) Appl. No.: 13/633,056

(22) Filed: Oct. 1, 2012

(51) Int. Cl. G06F 11/20

(52) U.S. Cl. 714/4.12; 714/4.1; 714/E11.089; 714/E11.09

(57) ABSTRACT

A primary server and a standby server operating according as a redundant server pair are connected to a common network, and the operational state of each is monitored by a first and a second client function each of which run on a device connected to the common network. Each of the client functions operate to notify the standby server in the event that the primary server ceases to be operational. The standby server determining whether the primary server is operational based upon notification received from both of the first and second client functions.

### BACKGROUND

1. Field of the Invention

The present disclosure relates to a process for controlling failover from a primary to a standby server, both of which are connected to a network and in communication with a software client which operates to initiate the failover process.

2. Background

Access to data/information stored or applications running in association with a network server can be made more or less available to a community of users depending upon the criticality of the data to the operation of an organization. Servers operating in a network environment can be configured so that data stored in association with the servers is always available, highly available or available provided the system in which it is stored is operational (normal availability). So for instance, if a user desires to access data associated with a server configured for normal availability, and the server is not currently operational, this data will not be available to the user.

One solution to the problem of data or application availability is to configure a server to include redundant modules/functionality (either hardware, software or both) running in a parallel, hot standby manner which maintains duplicate copies of the state of the server functionality/data at all times. One module can be designated as the current primary module and the other can be designated as the hot standby module. In the event that the primary module on the server fails, the standby module can transition to be the primary module without any loss (or minimum loss) of application availability. While highly available servers can guarantee very close to one hundred percent up-time for an application, they can be very expensive to purchase and/or maintain.

Another solution to the problem of providing data or application availability is to configure two servers to operate in tandem (redundant servers), one as a primary server and the other as a standby or hot standby server. In this configuration, data associated with the current primary server state (state can be data generated by an application for instance) is periodically transferred to the standby server, and if the primary server fails for any reason, the standby server can transition to operate as the primary server and take over running an application without any or with little loss of application or data availability. Typically, if a large volume of data is gathered or generated by an application running on a server, this data can be stored in a database maintained by a database management system (DBMS) running in association with the server. In the event that two servers are being operated as a primary and standby server, each server can store data generated by an application in two separate, minor databases, each database being maintained by a DBMS running on the primary and a DBMS running on the standby server. In the event that the primary server ceases to operate correctly, a system administrator can designate that the current standby server transition to become the primary server and then take the formerly primary server off-line for repair or servicing.

While manually controlling the transition (failover) of a server, currently operating as a standby server, to become the primary server is fine for some normal availability applications, the manual failover method is not appropriate for highly available applications. In such cases, another computational device (i.e., a third server) in communication with both the primary and standby servers can run a client application that operates to monitor the operational status of the primary and secondary servers. This client is referred to here as a quorum client. This quorum client can include functionality that operates to monitor the operational status (i.e., health) of both the primary and standby servers, and if the quorum client detects that the primary server is not operating correctly, it can notify the standby server of the primary's failure which can initiate an automatic failover process on the standby server. FIG. 1 shows a network (LAN/WAN) 10 comprised of a switch or router S/R 1 being connected to a network, such as a LAN or WAN, being connected to each of two servers S.0 and S.1, and also in communication with a quorum client QC running on a server which is not shown. Servers S.0 and S.1 can operate as either a primary or standby server in a redundant server configuration, and the quorum client operates to, among other things, detect if the servers S.0 and S.1 are operating correctly. If the quorum client detects the cessation of a heart beat signal (for any reason) from the primary server, it can convey this information to the standby server which initiates an automatic failover process and transitions to become the primary server. Each of the servers S.0 and S.1 operate to, among other things, run applications that collect or generate data/information that is stored and maintained in a database associated with each server by a database management system (DBMS) not shown. Also, each of the servers, S.0 and S.1 can have an application that operates to maintain equivalency between data/information maintained in their respective databases or in their respective on-board storage devices, such as local disk storage. This application data equivalency is typically referred to as data mirroring.

### BRIEF DESCRIPTION OF THE DRAWINGS

The present invention can be best understood by reading the specification with reference to the following figures, in which:

FIG. 1 shows a prior art network 10 in which a quorum server operates.

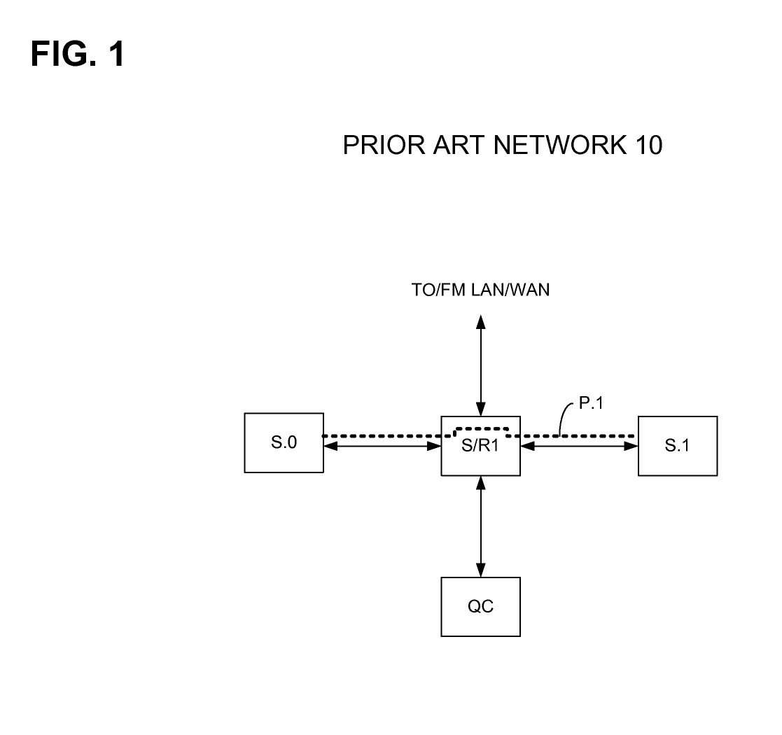

FIG. 2 shows a prior art network 20 in which a quorum server operates.

FIG. 3 shows a network 30 according to one embodiment of the invention.

FIG. 4 show a network 40 according to another embodiment of the invention.

FIG. 5 illustrates functionality comprising a redundant server comprising the networks 30 or 40.

FIG. 6 illustrates quorum client functionality included in networks 30 or 40.

FIG. 7 illustrates failover veto client functionality included in networks 30 or 40.

FIG. 8 is a diagram of failover logic running on a redundant server connected to either of the networks 30 or 40.

### DETAILED DESCRIPTION

As long as there is network connectivity between the quorum client and the primary server and standby server, an automatic failover process can proceed correctly. However, in the event that connectivity is lost (for any reason) between the quorum client and the primary server, the quorum client can send information to a standby server that results in the standby server erroneously initiating a failover process. Erroneously in this case means that during the time that connectivity between the quorum client and the primary server is lost, the primary server can continue to operate normally, and so there is no need to failover to the standby server. One problem associated with such an erroneous failover is that if both the primary and standby servers are operating in the role of primary server, it is possible that the primary server and the standby server can each be visible over the network to a different set of client devices. In this case, it is likely that each server will not receive data from all of its required resources (clients), and similar applications implemented in each of the primary and standby servers will likely operate on different data resulting in database images that are very different. As it is essential in a primary/standby server configuration that the data images between the two servers are substantially identical, running two servers in a primary role at the same time makes it very difficult or impossible to maintain mirrored data images between the two servers.

In order to mitigate or prevent the creation and maintenance of two different data images between the primary and standby servers in the event of network connectivity problems between the quorum client and the primary server, it was discovered that the network (LAN and/or WAN) to which the primary and standby servers and the quorum client are connected can be configured with one or more additional servers or computational devices running clients that operate to monitor the operational status of both the primary and secondary servers. The client running on each of the additional server is referred to here as a failover veto client (FVC). Each FVC can communicate with both the primary and the standby servers over a different path than the path over which the quorum client communicates with the primary and standby servers. Each of the FVC's can transmit information to the standby and primary servers indicative of the health of the other server. The standby server can then use this primary server health information received from the FVC to override a failover process initiated by the server health information received from a quorum client.

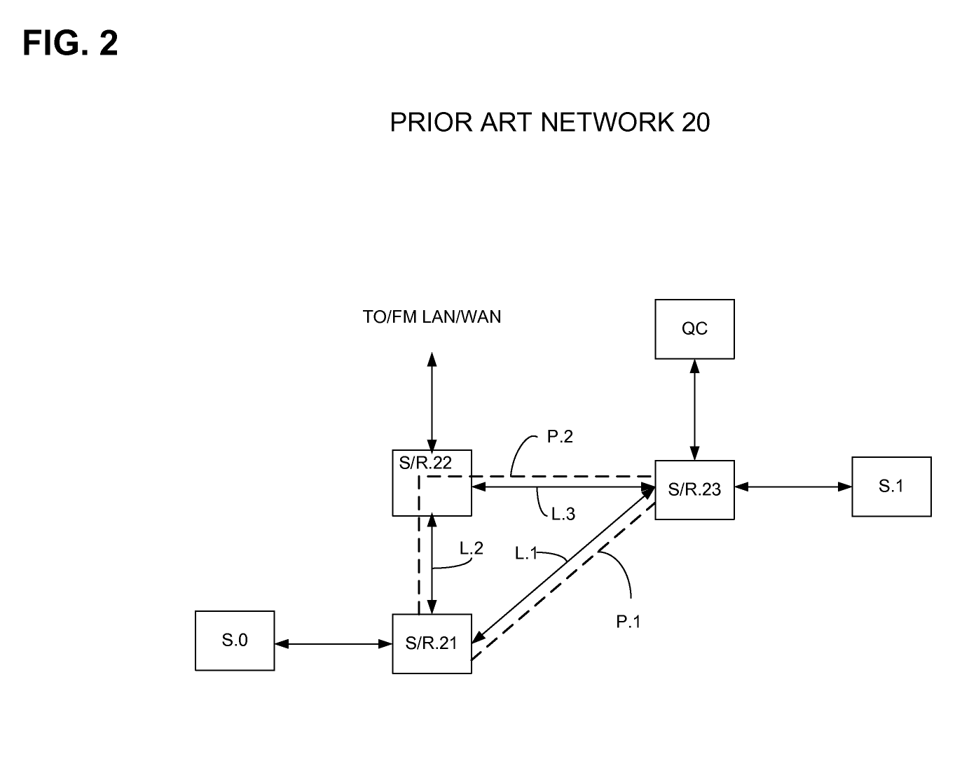

FIG. 2 is illustrative of a network 20 comprising two redundant servers, S.0 and S.1, three network switch/routers, S/R 21, S/R 22 and S/R 23, and quorum client, QC 24, running on a server which is not shown. Each of the two redundant servers S.0 and S.1 can operate as either a primary or standby server at any point in time, and they are both connected to the network 20 such that there are two distinctly different pathways (the pathways do not share a common network link), P.1 and P.2, between server S.0 and server S.1. In this case, the QC 24 is in direct communication with S/R 23, which is in the shortest path between server S.0 and S.1. Alternatively, QC 24 can be in direct communication with S/R 21. During operation, each of the redundant servers maintains local minor images of a database so that in the event that one server fails and its associated database is not accessible, the data is accessible by connecting to the other, redundant server. The means employed to maintain mirror database images will not be described here, as practitioners are typically familiar with such methods and methods for database minoring are commercially available. Further, functionality to provide database minoring can be implemented in QC 24, for instance. As described previously, the QC 24 can, among other things, operate to monitor the health of each server, S.0 and S.1, to determine whether they are sufficiently operational to support the application(s) running on them. The QC 24 can monitor the health of each server by detecting periodic heartbeat signals generated and sent by each of the servers, S.0 and S.1. More specifically, the QC 24 periodically sends a message to each of the servers, S.0 and S.1, requesting that each server send a heartbeat signal to them over the network 20. In response to the request from the QC 24, each server S.0 and S.1 generates and transmits a heartbeat signal to the requesting QC 24. While there are two pathways, P.1 and P.2, through the network 20 between server S.0 and S.1, due to the operation of standard network routing protocols (i.e., OSPF) running at each of the S/Rs, the heartbeat signal will typically be transmitted from server S.0 to the requesting QC 24 over the shortest path, which in this case is path P.1 over network link L.1.

Continuing to refer to FIG. 2, in the event that the link L.1 in path P.1 becomes inoperative for some reason, QC 24 may not receive a heartbeat transmitted by server S.0. within a specified period of time, and so will not notify the standby server that a heart beat was received. In this case the standby server is not able to discriminate between a network link failure and a server failure, and as a consequence concludes that the primary server is not operating correctly and can initiate a failover process to the role of primary server. Assuming, in this case, that the QC 24 does not receive the heartbeat due to a failure of link L1, then the failover process is initiated by the standby server erroneously, and as a result, users of an application running on the servers may experience either or both of a delayed access to the application, the loss of some data generated by the application, or there could be contention between the two servers for data received by the applications.

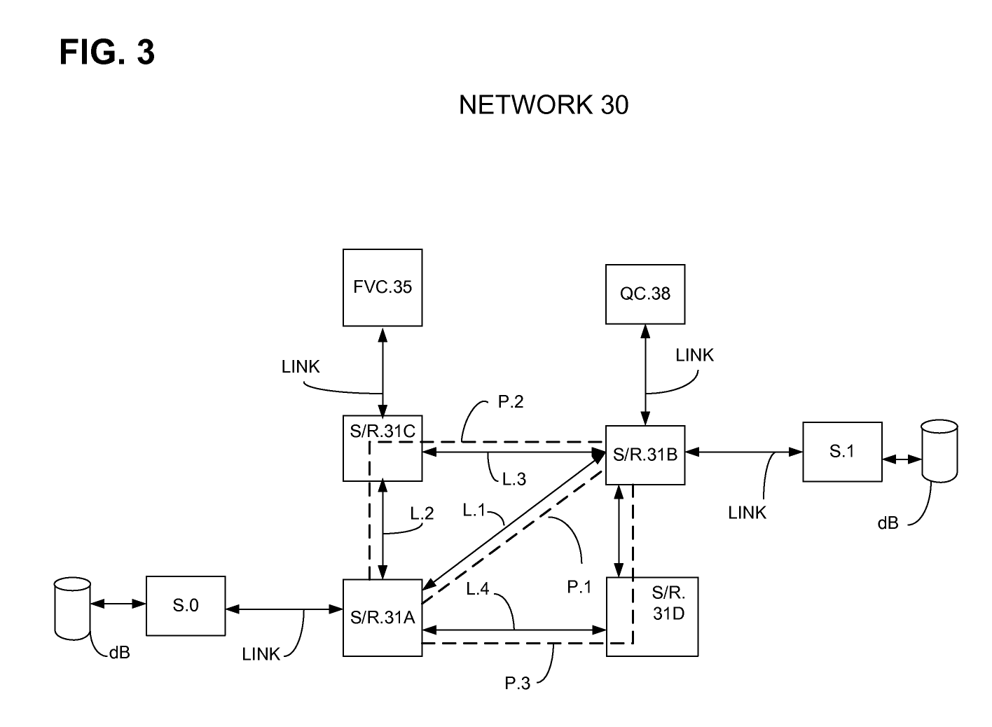

Referring to FIG. 3, in one embodiment, a failover veto client (FVC) 35 operates to provide primary server health information to a standby server that the standby server can employ to veto an erroneous failover procedure initiated as the result of the standby server not receiving primary server health information from a QC 38. As shown in FIG. 3, a network 30 is comprised of four switch/router devices, S/R 31A, S/R 31B, S/R 31C and S/R 31D, two host or server devices, S.0 and S.1, a QC 38 and at least one failover veto client (FVC) 35 running on a server (not shown) that is connected to S/R 31C. Server S.0 is connected over a network link directly to S/R 31A and server S.1 is connected over a network link directly to S/R 31B. Network 30 is configured such that there are three distinct pathways, P.1, P.2 and P.3, between server S.0 and server S.1. Pathway P.1 is comprised of network link L.1. pathway P.2 is comprised of network links L.2 and L.3 and pathway P.3 is comprised of network links L.4 and L.5.

According to the network 30 configuration shown in FIG. 3, FVC 35 is positioned in path P.2 to receive a heartbeat signal from both servers S.0 and S.1. According to this embodiment, and assuming that server S.0 is currently operating in the role of primary server, if QC 38 does not receive a heartbeat signal from server S.0 within a specified period of time (this interval is at least one heartbeat time interval), it will either not transmit a heart beat received (HBR) message to server S.1 or it will transmit a redundant server health (RSH) message to server S.1. A RSH message can be sent by QC 38 in the event that it does not receive a HB signal from the primary server, and the RSH message can have information indicative that a server (S.0 or S.1 for instance) is not operating correctly. In the event that server S.1 does not receive a HBR message within a specified period of time or it receives a RSH message, it can determine that server S.0 is no longer operational. Either of these events can result in server S.1 attempting to transition from a standby role to a primary role. However, and according to this embodiment, server S.1 will only transition to the primary role after it either does not receive a HBR message or it does receive a RSH message from the FVC 35. If, on the other hand, the FVC 35 does receive a heartbeat signal from server S.0 within the specified period of time then it can transmit a HBR message to server S.1. Immediately after receiving the HBR message from the FVC 35, the server S.1 can cancel the failover process that was initiated as the result of information it received from the QC 38. On the other hand, if server S.1 either does not receive a HRB message or it receives an RSH message from QC 38, and at substantially the same time server S.1 does not receive a HBR message or does receive an RSH message from FVC 35, then the normal failover process proceeds.

Alternatively, the QC 38 in FIG. 3 can be implemented on the server S.1 in Network 30. While implementing the QC 38 functionality in the server S.1 is problematical in as much as the QC functionality is lost in the event that server S.1 becomes inoperable, this configuration does save the cost of including an additional server in the network 30. According to this embodiment, the QC 38 can have substantially the same functionality as above, but instead of communicating with the server S.1 through S/R 31B, it communicates with the failover functionality in server S.1 over an internal server communication link/bus.

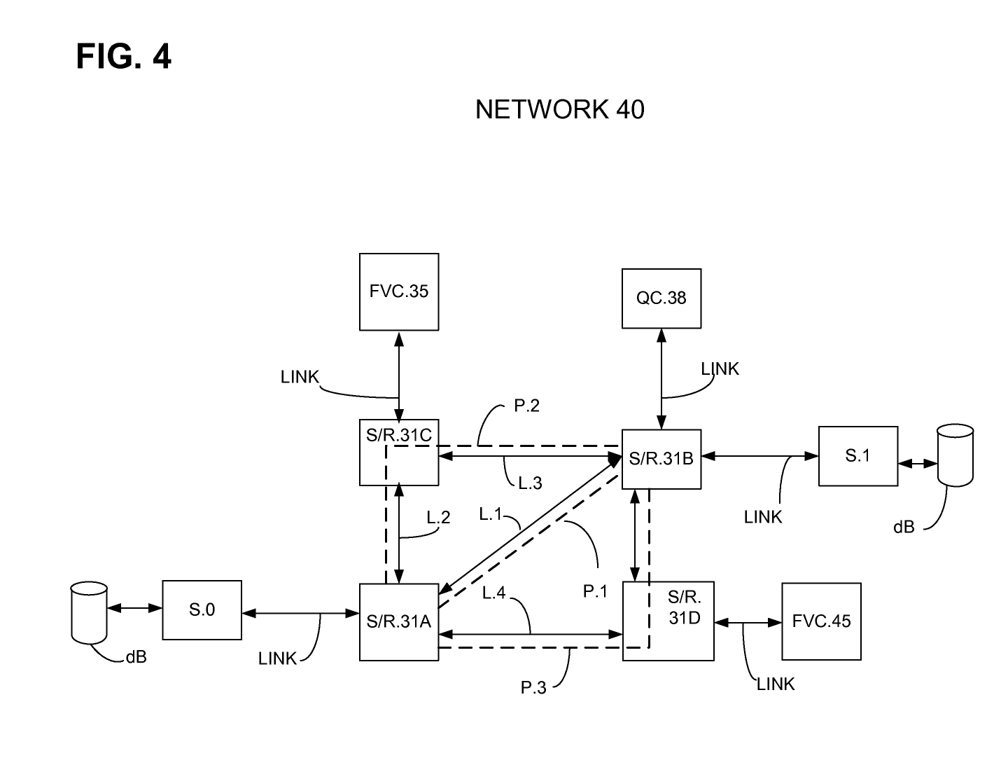

FIG. 4 illustrates another embodiment of the invention in which an FVC 45, having substantially the same functionality as FVC 35 described with reference to FIG. 3, is configured in network 40 in direct communication with server S/R 31D, and is in position to monitor heartbeat signals from both servers S.0 and S.1 over network pathway P.3. In another embodiment, both FVC 35 and FVC 45 can be configured into network 40 and in communication with S/R 31C and S/R 31D respectively. It should be understood that the invention is not limited to include one or two clients with functionality similar to that included in an FVC. Accordingly, separate FVC functionality can be positioned in some or all of a plurality of distinct network pathways to monitor heartbeats sent by both of two redundant servers, such as server S.0 and S.1.

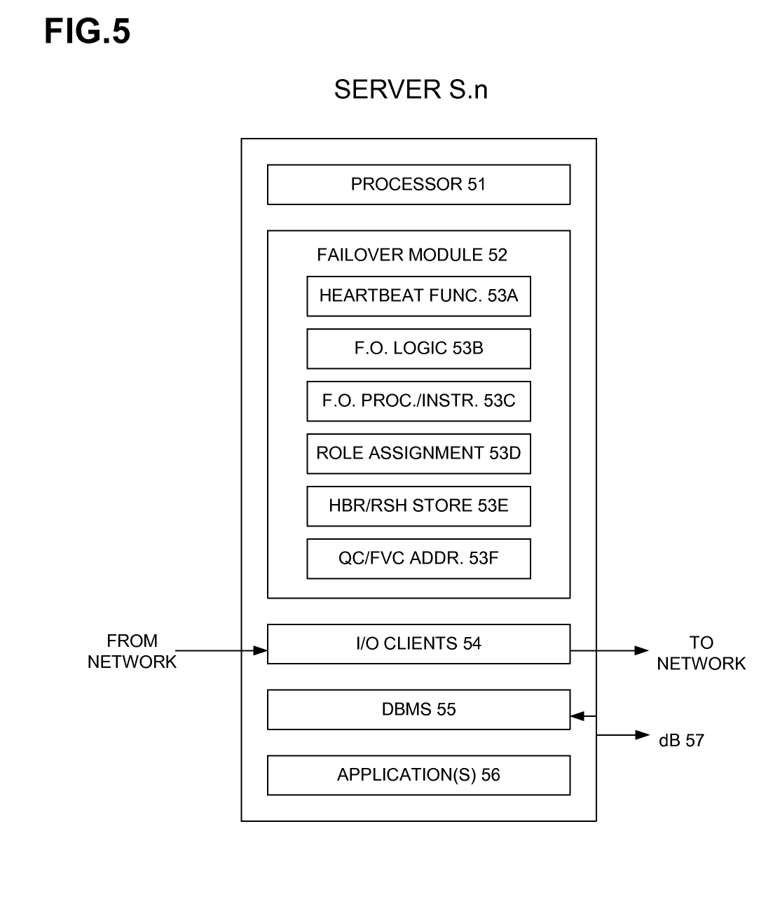

A detailed description of a server, S.n, will now be undertaken with reference to FIG. 5. Server S.n can represent functionality comprising either a primary server or a standby server in a redundant server pair, and it has functionality that is substantially similar to that of servers S.0 and S.1. Server S.n is comprised of a general purpose processor 51, a failover module 52, some number of input and output clients 54, a database management system (DBMS) 55 and associated database 57 (or some other file storage system), and one or more applications 56 (such as a hospital staff notification system). The general purpose processor 51 can be selected from among any commercially available general purpose processors and it generally functions to operate on data received by any one of the applications 56, according to instructions comprising the application, and to send the application data to the DBMS 55, for instance. As will be described in more detail below, the failover module 52 is comprised of a heartbeat function 53A, failover logic 53B, failover process instructions 53C, information 53D identifying the current role of the server S.n, a store 53E for HBR and RSH message information, and the IP addresses 53F of a server(s) in which a QC and one or more FVCs are running which are configured to communicate with the server S.n. The Input clients 54 can be in communication with any device, such as a nurse call station, that is connected or can be connected to the network in which the server S.n is operating, and the input clients generally operate to receive information/data from the network device and send the information/data to the appropriate applications running on the server S.n. After the information received by the application is processed, it can either be stored in the database 57, or it can be sent to the output client 54 which operates to transmit a message having the processed data to an end point, which can be any type of communication device for instance. The DBMS 55 as previously discussed manages the maintenance of the database 57 and manages access by application users to data stored in the database. And finally, the one or more applications 56 running on the server S.n can operate to process information/data received over the network from a nurse call station, such as an alarm/alert generated by the call station in response to an event receives by the station.

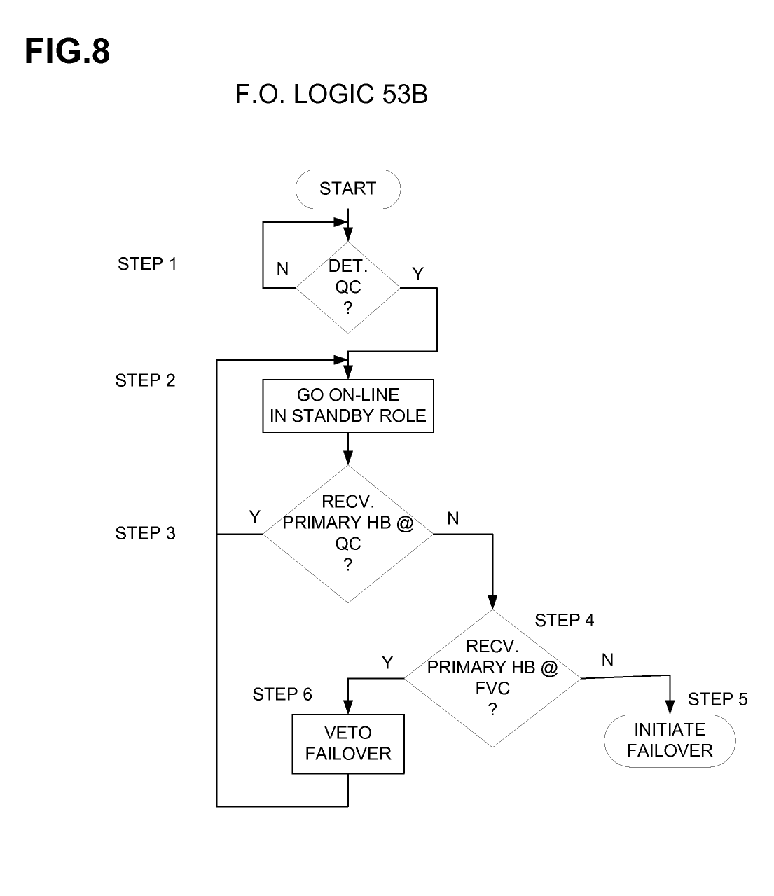

Referring again to the failover module 52 described above with reference to FIG. 5, the heartbeat function 53A operates to generate a heartbeat (HB) signal in response to receiving a request for a HB signal from either a QC, such as QC 38 in FIG. 3, or from one or more FVCs, such as FVC 35 described with reference to FIG. 3. The failover logic 53B will be described in detail later with reference to the logical flow diagram in FIG. 8, but briefly, this logic uses information in HBR and RSH messages received from a QC and one or more FVCs to determine whether or not to initiate a failover process. The failover process instructions 53C include instructions which the server S.n employs to effect the transition from its current standby or primary role, to a respective primary or standby role. As methods employed to effect such a transition in roles are well known to those familiar with server design and operation, the details of such methodologies are not discussed here. The current role assignment 53D includes information relating to the current role (primary or standby) assigned to the server. This role can be an initial, start-up role assigned to the server by a system administrator, or it can be the role that the server is currently operating in, due to a transition from its initially assigned role. Store 53E includes one or more recently received HBR and RSH messages and the information included in each. And finally, the server is configured with the IP addresses 53F of the servers in which the QC and FVC(s) are running. Configuring the server S.n with these IP addresses limits the reception of HBR and RSH messages to only those clients (QC and FVC) it is configured to receive these messages from. This limitation is necessary so that the server S.n does not receive messages from a QC and a FVC not assigned the IP address configured in 53F.

Each redundant sever, such as server S.n, is not permitted to assume an active role prior to establishing communication with the QC assigned the IP address stored in 53F. When powered up, one of the first operations performed by S.n is to determine (using logic not shown) whether the QC is on-line and operational. This redundant server S.n can, for instance, send a HB request message to the network address of the QC and wait to receive a HB response signal. If this signal is received, then the server S.n determines that the QC.n is on-line and operational.

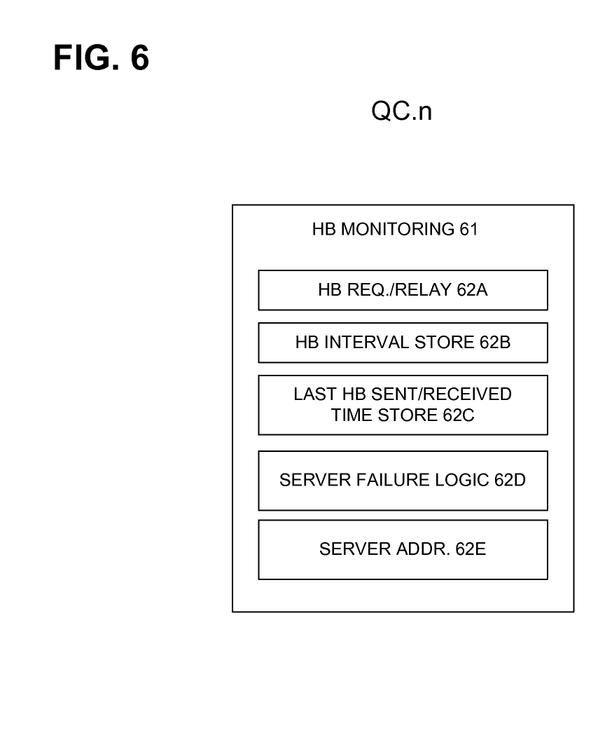

Functionality comprising a quorum client (QC.n) is now described with reference to FIG. 6. The QC.n is comprised of substantially the same functionality as the QC 38 described earlier with reference to FIG. 3. Generally, the QC.n provides startup control and heartbeat monitoring between the two redundant servers S.0 and S.1, and it provides information in messages (either HBR or RSH messages) to each redundant server that the redundant servers use in order to determine whether to transition from a current role to a different role or not. QC.n has a HB monitoring module 61 that is comprised of a HB request message generation and HB relay function 62A, a HB interval value store 62B, a last HB received time store 62C, optional RSH logic 62D, and a store including two IP addresses 62E, one for each of the redundant servers. The HB request message generation portion of function 62A operates to generate and transmit a HB request message to each of the redundant servers assigned the IP addresses included in the store 62E, it operates to record and store the time at which each HB request message is sent and the time at which each HB response signal is received in Store 62C. The HB relay portion of the function 62A operates to generate and send a HBR signal to the other one of the redundant servers S.1 and S.0 respectively. The HB interval value 62B includes the time interval, in seconds, at which a new HB request message is generated and transmitted to each of the redundant servers. The last HB sent/received time 62C includes the time (network time) at which the function 62A transmits a last HB request message and detects the time a most recent HB signal is received from each of the redundant servers.

The optional logic 62D employs the stored time at which the most recent HB request message is sent and the time at which a HB response signal is received to determine whether each server is still operational. The maximum period of time that the monitoring module 61 waits after sending a HB request and receiving a HB response signal before determining that a redundant server is non-responsive can be set/selected by a system or network administrator, and this time period is typically less than the HB interval time 62B. According to the operation of the logic 62D, the QC.n only sends a RSH message to each redundant server in the event that it has not received a response to a HB request message send to the other in the event that the failure logic determines that the primary server (S.0 or S.1) is non-responsive. In this case, the message sent to the standby server (S.1 or S.0) includes data indicating that the QC is no longer receiving a HB signal (or at least that it did not receive a response to the most recent request for a HB signal) from the primary server.

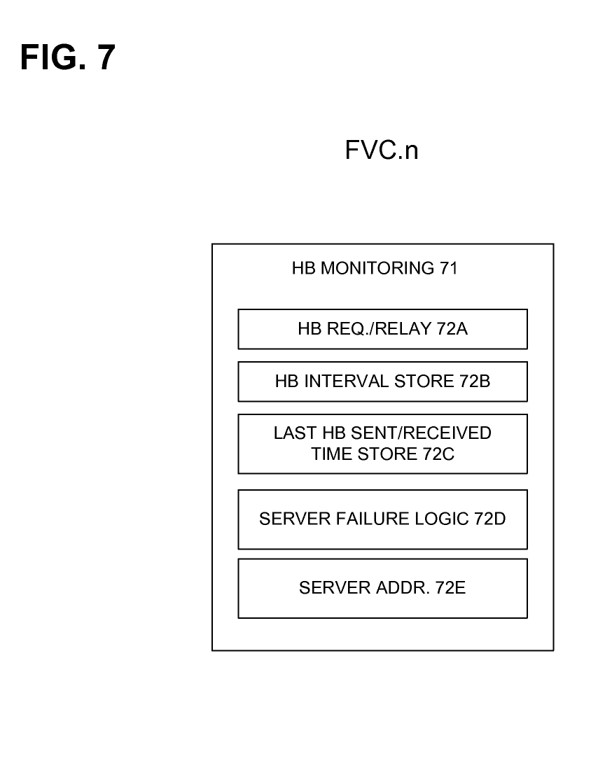

Functionality comprising a FVC.n, is shown with reference to FIG. 7. The FVC.n functionality is comprised of substantially the same functionality as the FVC 35 described earlier with reference to FIG. 3, and it is substantially the same as the functionality comprising the QC.n described with reference to FIG. 6 above. While the QC.n and FVC.n's operate in a similar manner to detect HB signals from each of the redundant servers and to report on the health or operational status of one redundant server to the other redundant server, the failover logic running on a standby redundant server uses information comprising a HBR or RSH message received from the FVC.n differently than information received from the QC.n in similar messages. Specifically, if the standby server, server S.0 or S.1, either does not receive a HBR message from the QC.n or it receives a RSH message (including information indicating that the primary server has failed), the failover logic running on the standby server immediately determines (examining information store 53E) whether at least one FVC, with which it is in communication, is still receiving a HB from redundant server S.0, and if the standby server determines that the FVC is no longer receiving a HB signal from server S.1, then the standby server will immediately start transitioning to the primary server role. However, in the event that information received by the standby server from one of the FVCs indicates that it is still receiving a HB signal, than the standby server will not start the failover process and will not transition to the primary role.

The operation of the failover logic 53B will now be described with reference to the logical flow diagram in FIG. 8. For the purpose of this description, it is assumed that the logic 53B is implemented in a redundant server that is configured to initially go on-line operating in the standby role. Subsequent to power being applied to the standby server, in Step 1 it attempts to communicate with a QC, such as the QC 38 described with reference to FIG. 3. More specifically, a heartbeat function (for instance) running on the standby server examines an IP address configured in store 53F associated with a server running the QC and send a HB request message to that IP address. Provided the server to which the message is sent is operational, it will response by sending a HB response message to the standby server. In Step 2, upon successfully establishing that it can communicate with the server running the QC, the standby server goes on-line operating in the standby role. In this role, the standby server maintains a minor image of a database maintained on a primary server as described earlier in the background section and in the standby role, this server is accessible to only the QC and any FVCs it is configured to communicate with. If in Step 3 the standby server becomes aware that the QC is not longer receiving a HB signal from the primary server the process proceeds to Step 4 and the standby server checks to see if at least one FVC is receiving a HB signal from the primary. If in Step 4 the standby server determines that the FVC is not receiving a HB signal, then it proceeds to Step 5 and initiates the failover process resulting in the standby server transitioning to operate in the primary server role.

Returning to Step 3 in FIG. 8, in this Step, the standby server examines the store 53E described earlier with reference to FIG. 5 to determine whether it received the most recently expected HBR message or a RSH message from the QC, and if the expected HBR message was received, the process returns to Step 2, otherwise the process proceeds to Step 4. Alternatively, if in Step 3 the standby server examines the store 53E and detects receipt of a RSH message, then the process proceeds to Step 4, otherwise the process returns to Step 2. Regardless, in Step 4 the standby server examines the store 53E to determine whether or not at least one FVC with which it is able to communicate received the most recently expected HB signal, and if a FVC did receive a HB, then the logic 53B prevents the standby server from initiating a failover sequence and the process returns to Step 2. On the other hand, if in Step 4 the standby server determines that the FVC did not receive an expected HB signal from the primary server, it immediately starts the failover process which causes the standby to transition to the primary server role.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method of inhibiting a failover process from a primary server to a standby server, comprising:
connecting the primary server and the standby server to a common network;
the standby server not receiving during a first period of time from a first common network client, monitoring the operation of both the primary and standby servers, an indication of an operational state of the primary server, and the standby server receiving during the first period of time from a second common network client, monitoring the operation of both the primary and standby servers, an indication that the primary server is operational; and
the standby server not transitioning to a primary server role based upon the indications of the operational state of the primary server operational state received from the first and second common network clients during the first period of time.

2. The method of claim 1, wherein the primary server and the standby server operate as a redundant server pair.

3. The method of claim 1, wherein the standby server operates in a hot standby mode.

4. The method of claim 1, wherein the first common network client runs on a first device connected to the network and the second common network client runs on at least a second device connected to the network.

5. The method of claim 4, wherein the second function runs on each of a plurality of network devices.

6. The method of claim 1, wherein the first common network client is in direct communication with a first path comprising the common network between the primary and standby servers and the second common network client is in direct communication with a second path in the network between the primary and the standby servers.

7. The method of claim 6, wherein the first path does not have any common network links with the second path.

8. The method of claim 1, wherein the operational state is comprised of information indicative of the operational health of either or both of the primary or the standby servers.

9. The method of claim 8, wherein the operational health is a heart-beat signal.

10. A method for determining the operational state of a primary server in a primary/standby server pair, comprising:
connecting a first and a second server to a common network, the first server operating in a primary server role and the second server operating in a standby server role;
a first common network client and a second common network client monitoring the operational state of the primary server, the first common network clients is in communication with the primary server over a first common network path and the second common network client is in communication with the primary server over a second common network path;
the first common network client not receiving operational state information from the primary server over the first common network path within a first period of time and indicating to the standby server that the operational state of the primary server is not received;
the second common network client receiving operational state information from the primary server over the second network path within the first period of time and indicating to the standby server that the primary server is operational; and
the standby server using the indications of the operational state of the primary server from the first and second common network clients to determine that the primary server is operational.

11. The method of claim 10, wherein the standby server is operating in a hot standby mode.

12. The method of claim 10, wherein the first and second common network paths do not have any common network links.

13. The method of claim 10, further comprising at least a third common network client in communication with the primary server over a third common network path wherein the third common network path does not have any network links in common with the first and second network paths.

14. The method of claim 10, wherein the operational state of the primary server is comprised of operational health information.

15. The method of claim 14, wherein the operational health information is a heart-beat signal.

16. The method of claim 10, wherein the indication that the operational state is not received by the first or the second common network clients comprises the clients not transmitting an operational status message to the standby server or the clients transmitting an operational status not received message to the standby server.

17. The method of claim 10, wherein the first period of time is a predetermined period of time.

18. The method of claim 17, wherein the predetermined period of time is a duration of time between the primary server transmitting two sequential heart beat signals.

19. A system for inhibiting the failover from a server operating according to a primary role to a server operating according to a standby role, comprising:
the primary server and the standby server connected to a common network;
a third server and a forth server connected to the common network and having a common network client that operates to monitor the operational state of the primary and the standby servers, and the standby server not transitioning to the primary server role in the event that it does not receive an indication from the common network client running on the third server of the operational state of the primary server and if it does receive an indication from the common network client running on the forth server that the primary server is operational.

20. The system of claim 19, wherein the primary server and the standby server operate as a redundant server pair.

21. The system of claim 19, wherein the standby server operates in a hot standby mode.

22. The method of claim 19, wherein the common network client running on the third server is in communication with a first common network path between the primary and standby servers and the common network client running on the forth server is in communication with a second common network path in the network between the primary and the standby servers.

23. The method of claim 22, wherein the first common network path does not have any common network links with the second common network path.

24. The method of claim 19, wherein the operational state is comprised of information indicative of the operational health of either or both of the primary or the standby servers.

25. The method of claim 24, wherein the operational health is a heart-beat signal.
